(19) United States
(12) Patent Application Publication
(10) Pub. No.: US 2017/0014865 A1
(43) Pub. Date: Jan. 19, 2017

(54) COATING COMPOSITIONS, APPLICATIONS THEREOF, AND METHODS OF FORMING

(71) Applicant: Scoperta, Inc., San Diego, CA (US)

(72) Inventors: Grzegorz Jan Kusinski, Moraga, CA (US); Justin Lee Cheney, Encinitas, CA (US)

(21) Appl. No.: 15/159,103

(22) Filed: May 19, 2016

Related U.S. Application Data
(63) Continuation of application No. 13/340,921, filed on Dec. 30, 2011, now abandoned.

(51) Int. Cl. B05D 5/08; B05D 7/22; C23C 4/067; C23C 4/12; C23C 4/08

(52) U.S. Cl. CPC B05D 5/083; C23C 4/12; C23C 4/08; C23C 4/067; B05D 7/222; B05D 2202/10; B05D 2350/65; B05D 2506/15; B05D 2254/04

(57) ABSTRACT

A method to protect and modify surface properties of articles is disclosed. In one embodiment of the method, an intermediate layer is first deposited onto a substrate of the article. The intermediate layer has a thickness of at least 2 mils containing a plurality of pores with a total pore volume of 5 to 50% within a depth of at least 2 mils. A lubricant material is deposited onto the intermediate layer, wherein the lubricant material infiltrates at least a portion of the pores and forms a surface layer. The surface layer can be tailored with the selection of the appropriate material for the intermediate layer and the lubricant material, for the surface layer to have the desired surface tension depending on the application.

### CROSS-REFERENCE TO RELATED APPLICATIONS

NONE

### JOINT RESEARCH AGREEMENT

This application describes and claims certain subject matter that was developed within the scope of a written joint research agreement between Scoperta, Inc., and Chevron U.S.A., Inc., which was in effect prior to the inventive activities resulting in the present application and claims.

### TECHNICAL FIELD

The invention relates generally to a wear-resistant coating for use in wear-prone, corrosive, and/or scaling environments, and/or environments where flow enhancement is needed, applications employing the coating, and methods to form the coating.

### BACKGROUND

Hydrophobic and oleophobic coatings have been developed for use in a number of applications, including but not limited to industrial/anti-fouling applications such as fluid transport, automatic applications for use as bore wall of car engines, oil & gas explorations including but not limited to oil-field tubulars, architectural structures, urban infrastructures, etc. In fluid transport applications, the interaction between the fluid and the pipeline surfaces effectively draws energy out of the fluid resulting in a net pressure loss in the fluid across the inlet and outlet of the pipeline. In some applications, abrasive particles in the flowing fluid can damage the coatings, which would otherwise enhance fluid flow through the reduction of surface friction, and eventually negate the beneficial fluid flow effects of the coating.

In some applications such as in many oil extraction operations, the energy loss in the flowing liquid results in decreased production rates as well as overall production. In other applications, this energy loss must be overcome in some way, such as through pumps, creating additional costs. Energy is extracted from the liquid due to the inability of the liquid layer to resist shear forces, which creates the no-slip condition at the fluid to surface boundary. The no-slip condition creates a boundary layer of reduced velocity in the fluid. This type of interaction is common in most conventional operations such as the flow of oil in a steel pipe. However, it is known that in certain conditions, slip at the fluid to surface interface can occur. The energy reduction in the flowing fluid decreases when slip at the interface occurs.

The wettability of the fluid on the surface is one of the factors known to create slip. Slip occurs when the interaction forces within the fluid are stronger than those between the fluid and the solid interface. Studies have shown that hydrophobic solid surfaces (in the case of water transport) and oleophobic surfaces (in the case of oil transport) can result in slip, and thereby limit the amount of energy extraction in the liquid.

There is a need for coatings and coating materials with improved flow enhanced performance properties even under abrasive conditions. There is also a need for improved methods to form such coatings.

### SUMMARY OF THE INVENTION

In one aspect, the invention relates to a method for providing protection and modifying the surface properties of article having a substrate as a surface. The method comprises: depositing onto at least a portion of the substrate an intermediate layer having a thickness of at least 2 mils containing a plurality of pores with a total pore volume of 5 to 50% within a depth of at least 2 mils; depositing a lubricant material onto the intermediate layer for the lubricant material to infiltrate at least a portion of the pores; wherein the lubricant material is selected to provide the article with any of: oleophobic and hydrophobic surface layer; oleophobic and hydrophilic surface layer; super-oleophobic surface layer; super-hydrophobic surface layer; and scale resistant surface layer.

In another aspect, the invention relates to a method for providing protection and modifying the surface properties of an oil tubular good having a substrate as a surface. The method comprises: depositing onto at least a portion of the substrate of the oil tubular good an intermediate layer having a thickness of at least 2 mils containing a plurality of pores with a total pore volume of 5 to 50% within a depth of at least 2 mils, the intermediate layer comprising a Ni-based or an Fe-based metal alloy; depositing a lubricant material onto the intermediate layer for the lubricant material to infiltrate at least a portion of the pores, the lubricant material comprises; wherein the substrate coated with the intermediate layer and the lubricant material is characterized as having a surface tension of less than 30 dynes/cm and enhanced resistance to sand abrasion as characterized by a material volume loss of less than 75 cubic millimeters as measured according to ASTM G65-04 standardized method Procedure B.

In yet another aspect, the invention relates to a method for providing protection and modifying the surface properties of article having a substrate as a surface. The method comprises: depositing onto at least a portion of the substrate an intermediate layer having a thickness of at least 2 mils, the intermediate layer comprises a material selected from metal alloys, ceramic based materials, or combinations thereof containing a plurality of pores with a total pore volume of 5 to 50% within a depth of at least 2 mils; depositing a lubricant material onto the intermediate layer for the lubricant material to infiltrate at least a portion of the pores; wherein the material in the intermediate layer and the lubricant material are selected to provide the article with a surface layer having at least one of: a) oleophobic and hydrophobic property as characterized as having a surface tension property below 20 dynes/cm; b) hydrophilic property characterized as having a surface tension above 75 dynes/cm; c) super-oleophobic property characterized as having a surface tension of below 10 dynes/cm; and d) scale resistant property characterized as reducing growth rate of mineral scale on a substrate comprising steel components by at least 25% or reducing scale adhesion strength on on a substrate comprising steel components by at least 25%.

In one aspect, the invention relates to an article having at least a portion of its surface modified to change the surface properties. The article has at least a portion of its surface coated with an intermediate layer having a thickness of at least 2 mils containing a plurality of pores with a total pore volume of 5 to 50% within a depth of at least 2 mils; a surface layer comprising a lubricant material applied onto the intermediate layer, wherein the lubricant material infiltrates at least a portion of the pores, and the lubricant material is selected to provide the article with any of: oleophobic and hydrophobic surface layer; oleophobic and hydrophilic surface layer; super-oleophobic surface layer; super-hydrophobic surface layer; and scale resistant surface layer.

In another aspect, the invention relates to an oil tubular good, which has at least a portion of its interior surface modified to decrease pressure losses in contact with fluids carried within the interior surface. The oil tubular good comprises: an interior surface coated with an intermediate layer having a thickness of at least 2 mils containing a plurality of pores with a total pore volume of 5 to 50% within a depth of at least 2 mils, the intermediate layer comprising a Ni-based or an Fe-based metal alloy, the intermediate layer applied by a thermal spray process; a surface layer comprising a lubricant material applied onto the intermediate layer, wherein the lubricant material infiltrates at least a portion of the pores, and wherein the interior surface is characterized as having a surface tension of less than 30 dynes/cm and enhanced resistance to sand abrasion as characterized by a material volume loss of less than 75 cubic millimeters as measured according to ASTM G65-04 standardized method Procedure B.

### BRIEF DESCRIPTION OF THE DRAWING

FIG. 1 is a scanning electron micrograph detailing a typical thermal spray coating structure, showing porosity embedded throughout coating thickness.

FIG. 2 is a scanning electron micrograph (SEM) of an examplary coating embodiment.

FIG. 3 is another SEM of an embodiment of a coating.

FIGS. 4A, 4B are diagrams illustrating various embodiment of a process to apply the coating of the invention in stages.

FIGS. 4C and 4D are diagrams illustrating expected wear of an embodiment of a coating of the invention after undergoing service in an abrasive environment.

### DESCRIPTION

The following terms will be used throughout the specification and will have the following meanings unless otherwise indicated.

A “layer” is a thickness of a material that may serve a functional purpose including but not limited to erosion resistance, reduced coefficient of friction, high stiffness, or mechanical support for overlying layers or protection of underlying layers.

“Oil” is to be understood as having its common meaning to cover a wide variety of unctuous substances not miscible with water. Examples include oils of animal, vegetable, or mineral origin, as well as synthetic oils. Particular examples of oils include petroleum-based products, such as crude oil and products distilled therefrom, such as kerosene, gasoline, paraffin, and the like. In some embodiments, the oil comprises an industrial lubricant such as bearing oil or light turbine oil.

“Oleophilic” refers to the property having a strong affinity for oils.

“Oleophobic” refers to the property of having a reduced or no affinity for oils. The oleophobicity of a material can be rated as described in the Oil Rating test according to AATCC test 118-1997, which evaluates a material's resistance to wetting by oil. Failure occurs when the wetting of the material, as determined by clarification of the material, occurs within 30 seconds. The higher the value from the oil wetting test, the greater the oleophobicity of the material being tested. In one embodiment, oleophobicity is evaluated based on the contact angle, measured wherein a drop of reference oil, e.g., hexadecane, is disclosed on a flat surface consisting essentially of the material. The nominal contact angle is a measurement of the nominal wettability of the material. A surface is defined as oleophobic when the contact angle is greater than 30°. Highly oleophobic means a contact angle of 50 to 100°. “Super-oleophobic” means a contact angle of greater than 100°, e.g., 100° to about 160°.

“Diffusion” refers to a process where two different surfaces comprising different materials are in contact, upon the application of sufficient energy, atoms from one surface move, infiltrate, diffuse into the surface of, or fuse with material in the other surface, resulting in an intermediate compound formed by this diffusion.

“Amorphous metal” refers to a metallic material with disordered atomic scale structure. The term can sometimes be used interchangeably with “metallic glass,” or “glassy metal,” or “bulk metallic glass” for amorphous metals having amorphous structure in thick layers of over 1 mm.

“Coating” is comprised of one or more adjacent layers and any included interfaces. In one embodiment, a coating layer is placed on the substrate of the object to be protected. In another embodiment, “coating” refers to the top protective layer.

“Substrate” refers to a portion, or all of the surface of an article or of an object to be protected by a coating of the embodiment. The substrate can be metallic or non-metallic, e.g., plastic, ceramic, etc., or any combinations thereof for which protection by the coating is desired. The object to be coated can be of any shape. For example, the object can be in the form of panels, bars, blocks, sheets, foils, rolls, tubes, cubes, ingots, wires, balls, or mesh. The object can be the article in its final form, or a preform which will be later made into the article. The object can also be in the shape of tools, dies, the interior of a structural component such as a pipe, a vessel, or a tank.

In one embodiment, the invention relates to coatings which alter the surface properties relevant to fluid flow, such that the overall energy loss in fluid transport system can be minimized, comprising a lubricant layer deposited onto an intermediate layer deposited onto the substrate of the article to be protected. In one embodiment, the intermediate layer comprises any of metals, ceramic materials and combinations thereof. In one embodiment, the lubricant material creates a desired ‘slip condition’, whereas the fluid does not ‘wet’ the solid surface thereby exhibiting non-Newtonian behavior. Achieving the ‘slip condition’ minimizes the energy loss in the fluid and allows the fluid to be transported at a greater volume rate. Achieving the ‘slip condition’ is particularly advantageous in applications including but not limited to oil flow in engines, oil production, etc. In oil and gas exploration applications, reducing the energy loss in the flowing oil equates to higher productivity levels (bbls/day) and total production potential (bbls).

In other embodiments, the invention relates to methods to apply coatings with improved properties, having an intermediate layer with porosity used in tandem with a lubricant material to create a coating with advantageous properties for fluid transport.

Intermediate Layer:

The intermediate layer is the layer immediate to the substrate to be protected, applied onto the substrate to provide a durable protection having sufficient porosity for subsequent infiltration by the lubricant material. The durable protection properties for the substrate can be any of corrosion protection, increased wear resistance, etc. The intermediate layer has a thickness ranging from 2 to 100 mils (0.002 to 0.1 inches) in one embodiment; from 5 to 50 mils (0.005 to 0.05 inches) in a second embodiment; and from 10 to 30 mils (0.01 to 0.03 inches) in a third embodiment.

In one embodiment, the intermediate layer comprises any of metals, metal alloys, ceramic materials and combinations thereof, having pores or voids for infiltration by the lubricant material. The composition of the intermediate layer varies according to the end-use application of the coating. In one embodiment, the intermediate layer comprises any of ceramic materials; cermet based (intermetallic) materials; metal matrix composites; nanocrystalline metallic alloys; amorphous alloys; hard metallic alloys; carbides, nitrides, borides, or oxides of elemental tungsten, titanium, niobium, molybdenum, iron, chromium, and silicon dispersed within a metallic alloy matrix, and combinations thereof. In one embodiment, the ceramic materials are selected from any of carbides, nitrides, carbo-nitrides, borides, sulfides, silicides, and oxides of silicon, aluminum, copper, molybdenum, titanium, chromium, tungsten, tantalum, niobium, vanadium, zirconium, hafnium, and combinations thereof. Examples of suitable intermetallic materials include, but are not limited to, nickel aluminide, titanium aluminide, and combinations thereof.

In one embodiment, the intermediate layer comprises a diamond-like-coating (DLC) or combinations thereof as disclosed in US Patent Publication No. 20110220415A1, incorporate herein by reference in its entirety. In another embodiment, the metal alloy comprises a wear-resistant Ni-based or Fe-based material (amorphous, nanocrystalline, or crystalline). In one embodiment, the wear-resistant metal alloy comprises (in wt. %): Ni—balance; Cr—28; Mo—11; B—0.4; Si—1; Ti—0; and Al 0. In another embodiment, the Ni-based alloy is of the composition: Ni—balance; Cr—20; Mo<13; B—0; Si<6; Ti<0.25; and Al<2. In another embodiment, the intermediate layer comprises a Fe-based composition with: Fe—balance; V—5; Nb—5; Mo—0; Cr—12; B—2.75; Al—10; and Si—3.6. In another embodiment, the Fe-based composition comprises: Fe—balance; V—0; Nb—0; Mo—4.6; Cr—24.6; B—2.75; Al—0; and Si—1.5.

In the intermediate layer, there are plurality of pores, with at least a portion of the pores are interconnecting, e.g., forming passages that can also be infiltrated or filled out by the lubricant material. The pores or voids (as used herein, the term “pores” include interconnecting passages) are expressed as pore volume, ranging from 5 to 50% in one embodiment; from 10 to 40% in a second embodiment; and from 15 to 30 in a third embodiment. In one embodiment, the pore volume within a depth of 25% of the total depth of the intermediate layer (away from the substrate) has a pore volume ranging from 10 to 40%, with the depth layer adjacent to the substrate having less pore volume.

Surface Layer Comprising Lubricant Material:

After the deposition of the intermediate layer, a surface layer comprising at least a lubricant material is applied for the lubricant material to infiltrate at least a portion of the pores in the intermediate layer for a depth of at least 2 mils (from the surface of the intermediate layer in contact with the lubricant material). At least a portion of the pores means at least 15% of the pores at a depth of at least 2 mils in one embodiment; and at least 25% of the pores at a depth of at least 2 mils in a third embodiment, and at least 50% of the pores at a depth of at least 2 mils in a third embodiment. In yet another embodiment, at least 15% of the pores at a depth of at least 5 mils from the surface of the intermediate layer are penetrated by the lubricant material. In another embodiment, at least 15% of the pores at a depth of at least 25% of total thickness of the intermediate layer being infiltrated by the lubricant material.

Lubricant material refers to lubricant particles in solid, gel, or liquid form which subsequently cures or which creates coating and/or cures upon heating. In one embodiment, the lubricant material resists degradation upon exposure to elevated temperatures. For example, temperature ranges for many automotive applications in or near the engine are typically at or above 160° C. In one embodiment, the lubricant materials are resistant to degradation and are oleophobic with stable ratings at or greater than 300° C.

The surface layer comprising the lubricant material has a thickness ranging from 0.05 to 10 mils (0.0005 to 0.01 inches) in one embodiment; from 0.5 to 6 mils (0.0005 to 0.005 inches) in a second embodiment; and from 1 to 3 mils (0.001 to 0.003 inches) in a third embodiment. The thickness here refers to the thickness of the surface layer on top of the intermediate layer, as some of the lubricant material infiltrates the voids in the intermediate layer and becomes part of the intermediate layer. This layer after application and/or curing may have a thickness of 0 mils or less, as the lubricant material “sinks” in and infiltrates at least a portion of the voids of the intermediate layer.

In one embodiment, the lubricant material is in solution which infiltrates the pores and subsequently cures as solid. In another embodiment, the lubricant material comprises a plurality of particles in a solvent matrix as a slurry, an emulsion, or in suspension. The particles have an average particle size of at least 1 micron in one embodiment; less than 50 microns in a second embodiment; less than 10 microns in a third embodiment; 2-25 microns in a fourth embodiment; and of sufficiently small sizes to infiltrate the pores and flow through the interconnecting channels the intermediate layer. In another embodiment, the lubricant material is deposited through a gaseous process, e.g., chemical vapor deposition (CVD), plasma enhanced chemical vapor deposition (PECVD), or any other vapor based deposition process known in the art.

In one embodiment, the particles are selected from the group consisting of polytetrafluoroethylene (PTFE), graphite, molybdenum disulfide, tungsten disulfide, boron nitride, lead oxide, indium fluoride, cadmium fluoride, cuprous chloride, barium oxide, silver sulphate, cadmium iodide, zinc sulphate, zirconium chloride, nickel fluoride, molybdenum oxide, lead iodide, lead sulfide, lead fluoride, bismuth iodide, zirconium iodide, strontium oxide, manganese chloride, barium sulfide, and combinations thereof. In another embodiment, the lubricant comprises at least one of lithium stearate, zinc stearate, calcium stearate, aluminium stearate, ethylene bis stearamide, silicone compounds such as polysiloxanes, and combinations thereof, in a solvent matrix in an amount ranging from 0.1 to 90 wt. %. Examples of silicone compounds include but are not limited to silicon compound is selected from the group consisting of a silane, an alkoxysilane, a fluorosilane, a siloxane, a silazane, and derivatives thereof.

The solvent matrix for the lubricant material can be an aqueous solution, or a polymer such as a fluorinated solvent, heptane, ethanol, butyl acetate, etc. Other examples include but are not limited to conductive polymers, gutta-percha, phenolic resin, synthetic rubber, or vinyl polymer as a solvent matrix. In one embodiment, the solvent matrix may comprise additional components such as crosslinking agents, curing agents, wetting agents, dispersing agents, inhibitors, including but not limited to surfactants, alcohols, low surface tension materials, and the like.

The selection of the materials for the solvent matrix, as well as the optional additional components, can be tailored to obtain the desired final characteristics of the surface layer. For example in one embodiment, the solvent for the matrix is selected from any of hydrophilic solvents such as butyl acetate, xylene, butyl glycol acetate, dimethyl formamide, N-methylpyrrolidone, and combinations thereof, for a coating that exhibits hydrophilic characteristics.

In one embodiment, the lubricant material comprises PTFE and perfluoroalkyl vinyl ether (PAVE) in a weight ratio of 1:10 to 10:1 PTFE to PAVE. This composition is resistant to both water and oil and retains these resistant properties at high temperature for extended period of time. In one embodiment, PAVE is perfluoromethyl vinyl ether (PMVE), in a weight ratio of PMVE to PTFE of 3:7 to 7:3. In another embodiment, the lubricant material is applied in the form of a sol-gel mixture, comprising at least one silane and/or alkoxysilane, and at least one fluoroalkylsilane and/or fluoroalkoxysilane in a solvent including but not limited to alcohol, water, acid, and mixtures thereof. In another embodiment, the lubricant material is a fluoridated hydrocarbon comprising polymerized acrylic compounds.

In one embodiment, the surface layer comprising the lubricant material may be textured to increase the surface resistance to sand abrasion. The texture may be in the form of depressions, protrusions, porous solids, indentations, or the like. The texture may have features including bumps, cones, rods, wires, channels, substantially spherical features, substantially cylindrical features, pyramidal features, prismatic structures, combinations thereof, and the like.

Methods for Forming Coatings:

In one embodiment, the coating is applied by first depositing the intermediate layer in contact with the substrate, then applying the lubricant material onto the intermediate layer as the surface layer. The intermediate layer may be applied in multiple passes to produce one layer. The passes may comprise the same or different materials in terms of compositions and/or concentrations. For example, a concentration rich in hydrophilic materials such as zinc oxide, tin oxide, and the like. Similarly, the lubricant material may be applied in multiple passes forming the surface layer. The passes may comprise the same or different lubricant materials in terms of composition as well as concentration. For example, the first pass may include lubricant materials of smaller particle sizes than in subsequent passes.

In one embodiment prior to the application of the intermediate layer, the surface of the substrate is given a cleaning to remove all diffusion barriers such as paint, coatings, dirt, debris, and hydrocarbons. The surface is optionally given an anchor profile abrasive blast, ranging in one embodiment from 0.5 mils (0.0254 mm) to 6 mils (0.1524 mm).

In one embodiment, the intermediate layer is applied using a thermal spray process. Thermal spray is particularly advantageous because it can be used to deposit materials such as metal or metal-oxide coatings at a high production rate (e.g., 25-50 lbs./hr), and which inherently contain porosity. Additionally, the porosity can be adjusted to a desired level and graded by controlling the spraying parameters. Embodiments of thermal spray include but are not limited to high velocity air fuel, high velocity oxygen fuel, combustion arc, electric twin wire arc spray (TWAS), HVOF, and plasma spray. In another embodiment, the intermediate layer is applied on the substrate by brushing, using a spray device, or by dipping the article into the composition of the intermediate layer. Porosity in thermal spray coatings is found throughout the entire coating thickness, as shown in FIG. 1 of a typical coating of the prior art of an intermediate layer without a surface lubricant layer. By utilizing appropriate processing conditions such as relatively low atomizing gas pressures or the type of gas, porosity can be increased. Increased porosity in the intermediate layer is advantageous, because it allows for the lubricant material to be embedded into the structure forming a coating with improved properties. As the intermediate layer can be applied in multiple passes, each of the passes can be by the same of different application techniques. For example, in an application using TWAS, after the first few mils are applied, the atomizing pressure can be reduced to create a more porous layer on top of the denser initial coating adjacent to the substrate.

After the application of the intermediate layer, the lubricant material is applied onto the intermediate layer forming a surface layer. In one embodiment, the lubricant material is applied in the form of a slurry. In another embodiment, the lubricant material is applied in the form of a sol-gel, or in solution. The lubricant material can be applied onto the intermediate layer by any suitable method known in the art. Examples include but not limited to using devices and applications via dip coating, spread coating, spray coating, spin coating, brushing, imbibing, rolling, electro-deposition, and combinations thereof. After the application of the lubricant material, the surface layer can be optionally cured by heat or chemical treatment depending on the composition of the lubricant material. In one embodiment, the surface layer may be dried, for example, by heat at a sufficient temperature and for a sufficient amount of time for the lubricant material to infiltrate at least a portion of the pores. In one embodiment, the surface layer is cured at a temperature ranging from 25 to 250° C. In some embodiments, the curing is for a time ranging from 10 seconds to 48 hours.

In one embodiment after the application of the intermediate layer and before the application of the lubricant material, the intermediate layer is optionally treated to influence the behavior of the final coating layer. In yet another embodiment after the application of the surface layer comprising the lubricant material, the coating is optionally treated to further tune the properties of the final coating layer.

The optional treatment of the surface layer comprising the lubricant material in one embodiment is via texturing. In another embodiment, the optional treatment of the intermediate layer and/or the coating layer in one embodiment is via plasma treatment that to modify the wettability of the surface, rendering the treated surface hydrophobic or hydrophilic with the appropriate process gas(es). The plasma treatment affects only a few monolayers of the surface without changing the bulk properties of the materials. In one embodiment, the process gas is oxygen or air plasma that promotes surface oxidation and hydroxylation (OH groups) and increases surface wettability. In another embodiment, the process gas is carbon tetrafluoride (CF₄), which forms hydrophobic coating of fluorine-containing groups (CF, CF₂, CF₃) and decreases the wettability. In one embodiment, the coating of the intermediate layer and/or the surface layer comprising the lubricant material is applied using plasma deposition methods and equipment as disclosed in U.S. Pat. Nos. 7,838,793; 7,838,085; 7,629,031; 7,626,135; 7,608,151; 7,541,069; 7,444,955; and 7,300,684, the disclosures are incorporated herein by reference in their entirety.

It should be noted that the methods herein are not limited for the formation of a new coating, or the manufacture of a new article. In one embodiment, the method is employed to alter (tailor or tune) the surface characteristics of an article already in service, e.g., vessels or oilfield tubular goods including drill pipe, by depositing on the existing surface a coating of the invention. In another embodiment, the method is employed to apply the lubricant layer on an existing coating surface (e.g., a durable protective coating) to change the surface characteristics of the existing coating surface, including decreasing the pressure losses in fluid transport.

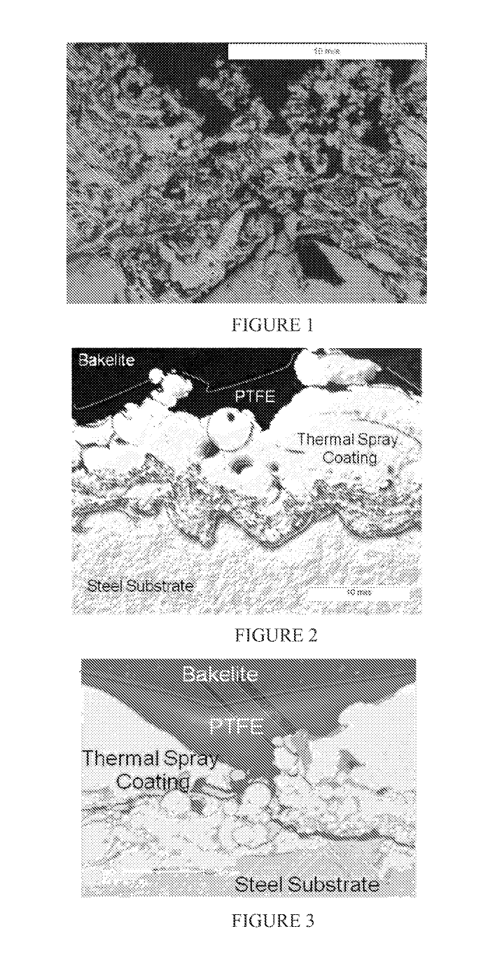

Reference will be made to the figures illustrating different of the invention. FIG. 2 is a scanning electron micrograph (SEM) of an embodiment of a coating comprising an Fe-based thermal sprayed coating embedded with PTFE organic media as the lubricant material. Notations in the SEM show the boundary between the PTFE layer and the Bakelite material used to mount the optimal specimen.

FIG. 3 is another SEM illustrating another embodiment of the coating comprising a Fe-based thermal spray coating infiltrated with PTFE. As the lubricant material penetrates into the pore structure of the thermal spray coating, it creates a bond between the metal (or metal-oxide) particles and the lubricant material.

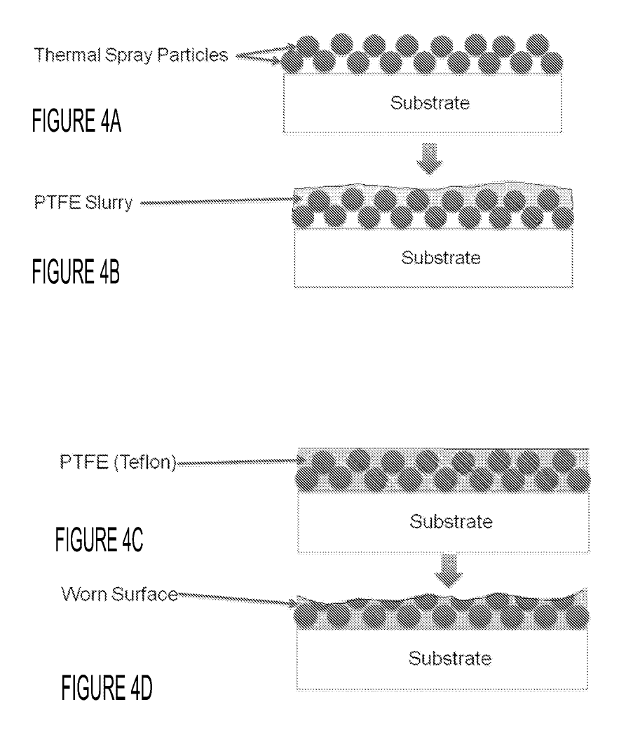

FIGS. 4A-4D are block diagrams schematically illustrating different embodiments to make coatings of the invention. FIG. 4A shows a thermal sprayed intermediate layer as applied on the substrate to be protected, with pores or voids in between the thermal sprayed particles. In FIG. 4B, a lubricant material, an organic slurry containing PTFE particles is applied onto the intermediate layer. In FIG. 4C, after a treatment step, e.g., curing or heat treating, the lubricant material infiltrates throughout the porosity of the intermediate layer of FIG. 4A. FIG. 4D illustrates the progression over time as the coating slowly wears away, the lubricant material is exposed with the partially worn coating surface still possesses the desired surface functionality demonstrated by both the intermediate layer and the lubricant material.

Properties of the Coatings:

Besides the functional properties offered by the protective intermediate layer, e.g., erosion resistance, hardness, corrosion resistance, wear resistance, etc., the coating layer also demonstrates functional surface properties ranging from oleophobicity to hydrophilicity and resistance mineral scaling by surface morphology alteration. The degree to which a solid surface repels a liquid mainly depends upon two factors: surface energy and surface morphology. The surface energy affects the liquid-solid surface interface by influencing the attractive forces between the liquid and solid at the molecular scale. Surface morphology alteration is at the micro-scale allowing an air layer to be maintained in the space between the asperities during liquid contact.

Selection of the appropriate materials for the intermediate layer and the lubricant material will be made according to end-use requirements such as physical, chemical, and mechanical properties required, environment conditions such as the properties of the fluid in contact with the substrate to be protected, cost, manufacturing, etc. In one embodiment, functional surface properties of the coating layer can be tuned (“tailored” or altered) by the appropriate selection of lubricant material. In another embodiment, the tuning is by a combination of select lubricant material and the intermediate layer via surface treatment and/or select composition. Examples of the tailored functionalities for the coating layer/the article coated by the layer, include but are not limited to:

1) Oleophobic and hydrophobic coatings showing very little wetting with water and oil, enabling a “slip condition” to occur between the coating surface and either flowing water, oil, or a mixture of both. In one embodiment of this type of coating, the layer shows an effective surface tension below 20 dynes/cm. An example is a coating with metal/metal oxide components (e.g., wear resistant Fe-based alloys or corrosion resistant Ni—Cr—Mo based alloys) for the intermediate layer, and a surface layer comprising lubricant particles such as PTFE, graphite, MoS₂ and the like.

2) Hydrophilic coatings having high wettability with water, desirable for applications in which the article is in contact with a mixed (oil/water) flow, as the coating surface will collect a water film effectively across the surface, enabling the oil to ride along the water film (a movable liquid) surface as opposed to a rigid solid surface and create an effective slip-like condition. In one embodiment of this type of coating, the layer shows an effective surface tension above 75 dynes/cm. An example is a coating with hydrophilic components such as tin oxide for the intermediate layer, and with a surface layer comprising lubricant particles in hydrophilic solvents such as butyl acetate.

3) Coatings with both super-oleophobic and super-hydrophobic properties simultaneously, in the form of alternating surface patches with alternating properties. Such coatings are used in applications include but are not limited to contact with fluids in mixed zones, allowing the surface to confuse the flow characteristics and reduce the height of the boundary layer, thereby minimizing the energy loss in the flowing fluid. In one embodiment of this type of coating, the surface layer possess patches that show an effective surface tension that is very hydrophilic (>>75 dynes/cm, e.g., >100 dynes/cm), in addition to possessing patches which are very oleophobic (<<25 dynes/cm, e.g., <10 dynes/cm). In one embodiment, the length scale for such patches ranges from 1 micrometer to 100 millimeters, and the surface areas ratio of oleophobic to hydrophilic zones ranges from 0.05 to 20. An example is a coating with hydrophilic components such as tin oxide for the intermediate layer, and with a surface layer comprising oleophobic components such as PTFE and the like.

4) Coatings that are resistant to the formation of mineral scale. Common mineral scale chemistries encountered in the oil and gas production industry include but are not limited to gypsum (calcium sulfate), halites, anhydrites, strontium sulfate, calcite, barite, and siderite. Scale is typically formed through the reaction of water soluble minerals, forming insoluble scale which adheres to production surfaces. An example is the reaction between sodium sulfate and calcium chloride to form gypsum. In one embodiment with this type of coating, the rate of scale growth on a steel surface is reduced by at least 25% or more. In another embodiment, the coating reduces the adhesion strength of mineral scale onto the surface by at least 25%. An example is a coating with metal/metal oxide components (e.g., wear resistant Fe-based alloys or corrosion resistant Ni—Cr—Mo based alloys) for the intermediate layer, and with a surface layer comprising a lubricant material comprising silicone compounds.

Besides the functional surface properties, the surface layer with the lubricant material provides surface protection in terms of dry sand abrasion properties as measured according to ASTM G65-04, Procedure B, characterized by a material volume loss of less than 75 mm³ in one embodiment; less than 50 mm³ in a second embodiment; and less than 40 mm³ in a third embodiment.

The coating layer further exhibits protective properties inherent in the durable protective intermediate layer. In one embodiment with the use of cermet materials, the layer shows excellent erosion resistant properties characterized as having a HEAT erosion resistance index of at least 5.0 and a K_{1C} fracture toughness of at least 7.0 MPa-m^{1/2}, as disclosed in U.S. Pat. No. 7,842,139, the disclosure is incorporated herein by reference in its entirety. In another embodiment with a metal alloy containing a high refractory content, e.g., Nb, V, Mo, or W, known to halt the development of sulphide scale, the layer exhibits a corrosion rate characterized less than 100 mpy (˜0.1 mm per year) in hot (350° F.) sulfuric acid (83% concentration) for two weeks according to ASTM G31-72. In yet another embodiment with an iron-based metal alloy as disclosed in US Patent Publication Nos. 20110064963A1 and 20110068152A1, incorporated herein by reference in their entirety, the layer has a bonding strength of at least 5000 psi adhesion strength according to ASTM D4541/D7234 on a 3.5 mil profile steel surface. In another embodiment, an adhesion strength of at least 10,000 psi. In another embodiment with an alloy comprises comprising iron and manganese in the range of 67 to 87 wt. %, niobium and chromium in the range of 9 to 29 wt. %, and boron, carbon and silicon in the range of 3 to 6.5 wt. %, as disclosed in US Patent Publication No. US20110100720A1, incorporated herein by reference in its entirety, the layer shows excellent wear resistant properties characterized by a dry sand abrasion material loss of less than 0.5 grams as measured according to ASTM G65-04 (2010) procedure A.

Applications for Use with Coatings:

Any suitable coating thickness may be used, with the thickness of the intermediate layer in contact of the substrate and the thickness of the surface layer comprising a lubricant material varying according to the end-use applications. In one embodiment, the coating has a thickness from 5-500 mils (0.005-0.5 inches) as the total thickness of the intermediate layer and the surface layer comprising the lubricant material. In another embodiment, the thickness ranges from 10-300 mils (0.01-0.3 inches). In a third embodiment, from 20 to 100 mils (0.02 to 0.1 inches).

Applications for use with such coatings include, but are not limited to, restoration and improvement of architectural structures and urban infrastructure, industrial, anti-fouling, optoelectronics (photovoltaics, fibers, displays), automotive, textile, and household. Industrial applications include but are not limited for use as coatings for oil pipes and tubular in the oil and gas (O & G) industry, coatings for drill stem assemblies, coatings for oilfield tubulars, vents in automotive gas sensor in automotive applications, and cylinder walls in engines in railway/automotive applications. In one embodiment of an application in the O&G industry, the coating is applied onto equipment for use in the drilling equipment, e.g., interior/exterior surfaces of downhole tubular goods to decrease the pressure loss upon contact with petroleum products.

### EXAMPLES

The following illustrative examples are intended to be non-limiting.

### Example 1

An Fe-based cored wire having a composition of {Fe(61.7%), Cr (12%), Nb (5%), V (5%), Si (3.6%), B (2.75%), Al (10%)} was thermally sprayed onto a steel substrate using the Twin Wire Arc Spray process in order to form an intermediate layer. The purpose of the intermediate layer herein is to form a highly wear resistant layer. Therefore, any coating with an ASTM G65-04, Procedure B, characterized by a material volume loss of less than 75 mm³ can be substituted effectively. Initially 1-5 mils of material was deposited using a gas atomizing process of 80-100 psi. After this initial material build-up, the atomizing pressure was reduced to 20-50 psi to create a more porous layer on top of the denser initial coating. The coating was built up to an additional thickness of 15-20 mils using a reduced atomizing pressure.

A slurry composed of 60 wt. % 0.05 to 0.5 micron colloidal PTFE suspended in water was then deposited onto the surface of the coating such that the coating was completely covered by the slurry. The assembly (substrate, intermediate layer with thermal spray coating, and surface with lubricant slurry) was then heat treated in several stages. First, the water was evaporated by achieving a temperature of above 100° C. for a period of 15 minutes. Second, the PTFE was melted and allowed to infiltrate the roughness and porosity of the thermal spray coating at a temperature of 350° C. for 30 minutes. the purpose of the PTFE lubricant material was to form a surface layer and provide the oleophobic properties to the coating performance. Thus, any material with a surface tension of less than 25 dyne/cm can be substituted effectively.

### Example 2

Samples from the assembly were micrographically evaluated as shown in FIGS. 2 and 3, showing infiltration of the PTFE into internal pores and cracks of the intermediate layer.

### Example 3-4

A comparable sample of an uncoated steel substrate and a sample of the coated substrate in Example 2 were tested according to ASTM G65-04 standardized method, Procedure B. The test method determines the resistance of metallic materials to scratching abrasion by means of the dry sand/rubber wheel test. The volume loss for the comparable uncoated substrate is over 90 mm³. The volume loss for Example 1 coated substrate sample is 25 mm³.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1-27. (canceled)

28. A method for producing a wear resistant coating on an inner surface of an oil tubular good, the method comprising:
depositing a metallic layer on the oil tubular good via a thermal spray process to produce a porous coating;
depositing a fluoropolymer in the form of a slurry on the porous coating; and
heating the fluoropolymer to infiltrate into pores in the porous coating of the metallic layer to form the wear resistant coating;
wherein the wear resistant coating comprises subsections of hydrophilic and hydrophobic regions.

29. The method of claim 28, wherein the wear resistant coating comprises alternating layers of metallic particles with a surface tension of 75 dynes/cm or higher and fluoropolymer regions with a surface tension of 20 dynes/cm or lower.

30. The method of claim 28, wherein the metallic layer is deposited by a twin wire arc spray process.

31. The method of claim 28, wherein a high atomization pressure of 80-100 psi is used to deposit a first portion of the metallic layer, and a low atomization pressure of 20-50 psi is used to deposit a second portion of the metallic layer.

32. The method of claim 31, wherein the first metallic layer is 1-5 mils in thickness, and the second metallic layer is 15-20 mils in thickness.

33. The method of claim 28, wherein the fluoropolymer comprises PTFE and the slurry is heated to at least 350° C. in order to infiltrate the pores.

34. The method of claim 28, wherein the metallic layer comprises a Ni-based alloy.

35. The method of claim 34, wherein the metallic layer further comprises Cr and Mo.

36. The method of claim 28, wherein the metallic layer comprises a Fe-based alloy.

37. The method of claim 36, wherein the metallic layer further comprises Al, Cr, and B.

38. The method of claim 37, wherein the metallic layer further comprises Nb, V, and Si.

39. A method for producing a wear resistant coating on an inner surface of an oil tubular good, the method comprising:
depositing a metallic layer on the oil tubular good via a thermal spray process to produce a porous metallic coating;
depositing an oxide containing slurry on the porous metallic coating; and
heating the oxide containing slurry such that it infiltrates into pores in the porous metallic coating to form the wear resistant coating;
wherein the wear resistant coating comprises hydrophilic properties.

40. The method of claim 39, wherein the wear resistant coating comprises a surface tension of 75 dynes/cm or greater.

41. The method of claim 39, wherein a twin wire arc spray process is used to deposit the metallic layer.

42. The method of claim 39, wherein a high atomization pressure of 80-100 psi is used to deposit a first portion of the metallic layer, and a low atomization pressure of 20-50 psi is used to deposit a second portion of the metallic layer.

43. The method of claim 42, wherein the first metallic layer is 1-5 mils in thickness, and the second metallic layer is 15-20 mils in thickness.

44. The method of claim 39, wherein the metallic layer comprises a Ni-based alloy.

45. The method of claim 44, wherein the metallic layer further comprises Cr and Mo.

46. The method of claim 39, wherein the metallic layer comprises a Fe-based alloy.

47. The method of claim 46, wherein the metallic layer further comprises Al, Cr, and B.

48. The method of claim 47, wherein the metallic layer further comprises Nb, V, and Si.
